(19) United States
(12) Patent Application Publication
(10) Pub. No.: US 2018/0194686 A1
(43) Pub. Date: Jul. 12, 2018

(54) A METHOD OF TREATING SILICON CARBIDE FIBERS

(71) Applicant: SAFRAN CERAMICS, Le Haillan (FR)

(72) Inventors: Sylvie LOISON, Saint Medard en Jalles (FR); Chrystel HUGUET, Margaux (FR); Adrien DELCAMP, Merignac (FR); Emilien BUET, Saint Medard en Jalles (FR)

(21) Appl. No.: 15/738,727

(22) PCT Filed: Jun. 21, 2016
(86) PCT No.: PCT/FR2016/051508

§ 371 Date: Dec. 21, 2017

(30) Foreign Application Priority Data
Jun. 24, 2015 (FR) 1555792

(51) Int. Cl. C04B 35/565; C04B 35/626; C04B 35/628; C04B 35/80; C04B 41/45; C04B 41/53; D06M 11/79; B29B 15/08; B29B 11/14

(52) U.S. Cl. CPC C04B 35/565; C04B 35/6265; C04B 35/62849; C04B 35/62868; C04B 35/62873; C04B 35/62894; B29L 2031/082; C04B 41/4558; C04B 41/5353; D06M 11/79; B29B 15/08; B29B 11/14; C04B 2235/5244; C04B 35/806

(57) ABSTRACT

A method of treating at least one silicon carbide fiber, the method including a) putting at least one silicon carbide fiber presenting an oxygen content that is less than or equal to 1% in atomic percentage into contact with an oxidizing medium in order to transform the surface of the fiber chemically and form a surface layer of silica; b) eliminating the resulting silica layer by putting the fiber obtained after performing step a) into contact with an acid liquid medium comprising at least hydrofluoric acid; and c) depositing an interphase layer on the surface of the fiber obtained after performing step b).

### BACKGROUND OF THE INVENTION

The invention relates to a method of treating at least one silicon carbide fiber for the purpose of improving the quality of the bonding between the fiber and an interphase layer.

It is known to fabricate parts out of composite material that is reinforced by silicon carbide fibers. Such fabrication comprises making a fiber preform based on silicon carbide fibers and having a shape that is close to the shape of the part that is to be fabricated, and then densifying the preform with a matrix.

In fiber-reinforced composite materials, it is well known that the characteristics of the fiber-matrix interface have a major influence on the mechanical properties of the material. It has been shown that satisfying behavior can be obtained, in particular with respect to impacts and crack propagation, by forming a thin interphase layer on the fibers prior to forming the matrix, which interphase layer may, by way of example, be made of boron nitride or of pyrolytic carbon deposited in the vapor phase. Nevertheless, it would still be advantageous to further improve the mechanical properties of parts made of composite material.

Documents WO 98/23555, WO 2013/153336, and FR 2 984 884 are also known. Those documents describe treating silicon carbide fibers with an acid solution. Also known is the publication by Bertrand et al., “Influence of strong fiber/coating interfaces on the mechanical behavior and lifetime of Hi-Nicalon/(PyC/SiC)n/SiC minicomposites”.

There thus exists a need to further improve the mechanical properties of composite material parts comprising fiber reinforcement based on silicon carbide fibers.

### OBJECT AND SUMMARY OF THE INVENTION

To this end, in a first aspect, the invention provides a method of treating at least one silicon carbide fiber, the method comprising at least the following steps:

a) putting at least one silicon carbide fiber presenting an oxygen content that is less than or equal to 1% in atomic percentage into contact with an oxidizing medium in order to transform the surface of the fiber chemically and form a surface layer of silica;

b) eliminating the resulting silica layer by putting the fiber obtained after performing step a) into contact with an acid liquid medium comprising at least hydrofluoric acid; and

c) depositing an interphase layer on the surface of the fiber obtained after performing step b).

The inventors have observed that silicon carbide fibers having an oxygen content that is less than or equal to 1% atomic percentage presents a surface layer that is responsible for decreasing the quality of the adhesion between the fibers and the interphase layer. This decrease in the quality of the fiber/interphase adhesion gives rise to a reduction in the mechanical properties of the composite material part formed from the fibers. Typically, the surface layer comprises carbon and at least one silicon oxycarbide (a compound based on silicon, carbon, and oxygen).

The present invention proposes a solution for eliminating the surface layer and consequently for improving the quality of the fiber/interphase bond so as to improve the mechanical properties of the composite material part obtained using silicon carbide fibers presenting an oxygen content that is less than or equal to 1% atomic percentage.

The thickness of the silica layer may be greater than or equal to 1 nanometer (nm), e.g. to 5 nm or 10 nm. During step a), the carbon present at the surface of the fiber is eliminated completely or in part and the oxycarbide comprising the elements Si, O, and C present at the surface of the fiber are converted in full or in part into silica.

In an implementation, the silica layer may be formed during step a) by putting the fiber into contact with an oxidizing gas phase, e.g. while imposing a treatment temperature that is greater than or equal to 600° C., e.g. greater than or equal to 650° C., the imposed treatment temperature possibly lying in the range 600° C. to 1000° C. for example, e.g. in the range 650° C. to 1000° C.

Using such temperature values during the treatment with the oxidizing gas phase serves advantageously to obtain relatively fast kinetics for forming silica.

In an implementation, during step a), the fiber may be treated with air and/or steam. Preferably, the oxidizing gas phase that is used during step a) is constituted by air.

Preferably, the treatment temperature imposed during step a) may lie in the range 900° C. to 1000° C.

Using such temperature values during the treatment with the oxidizing gas phase serves advantageously to obtain particularly fast kinetics for forming silica.

Preferably, the acid liquid medium used during step b) is in the form of an aqueous solution.

In an implementation, the acid liquid medium may comprise a mixture of hydrofluoric acid and of nitric acid.

In an implementation, the interphase layer may be a layer of boron nitride or of pyrolytic carbon. The interphase layer is preferably a layer of boron nitride.

In an implementation, the treatment is applied to a plurality of silicon carbide fibers, each presenting an oxygen content that is less than or equal to 1% atomic percentage.

The present invention also provides a method of fabricating a fiber preform comprising at least a step of treating a plurality of silicon carbide fibers by performing a method as described above and a step of forming a fiber preform by performing one or more textile operations using said plurality of fibers treated in this way.

The present invention also provides a method of fabricating a fiber preform comprising at least a step of forming a fiber preform by performing one or more textile operations using a plurality of silicon carbide fibers, each presenting an oxygen content that is less than or equal to 1% atomic percentage, and a step of treating said plurality of fibers, once the preform has been formed, by performing a method as described above.

The present invention also provides a method of fabricating a composite material part comprising at least a step of fabricating a fiber preform by performing a method as described above, followed by a step of forming at least one matrix phase of carbon or of ceramic material in order to densify said fiber preform.

By way of example, the composite material part may be a turbine engine part, e.g. a turbine engine blade.

### BRIEF DESCRIPTION OF THE DRAWINGS

Other characteristics and advantages of the invention appear from the following description given with reference to the accompanying drawings, in which:

FIGS. 1A to 1C are fragmentary and diagrammatic section views showing how the structure of a silicon carbide fiber varies while implementing steps a) and b) of the invention;

FIG. 2 is a photograph of the result obtained after performing an example method of the invention;

FIG. 3 is a photograph of the result obtained after performing a method that is not of the invention, in which steps a) and b) are not performed; and

FIG. 4 shows the results of a comparative traction test between a part obtained by performing the treatment of the invention and a part obtained by performing a treatment not of the invention (no step a)).

### DETAILED DESCRIPTION OF IMPLEMENTATIONS

The invention relates to treating silicon carbide fibers having an oxygen content that is less than or equal to 1% in atomic percentage. Consequently, the invention relates to treating silicon carbide fibers that are relatively poor in oxygen, which fibers are thus different from Si—C—O fibers that present an oxygen content outside the above-mentioned range.

By way of example, the fibers treated by the method of the invention may present a C/Si atomic ratio lying in the range 1 to 1.1, e.g. in the range 1 to 1.05. So-called “third generation” silicon carbide fibers, such as fibers of the “Hi-Nicalon S” type present such an atomic ratio, with an oxygen content that is less than or equal to 1% atomic percentage. Other types of silicon carbide fiber may be treated by the method of the invention, such as “Hi-Nicalon” type fibers, which present a C/Si atomic ratio lying outside the above-mentioned ranges, but that present an oxygen content that is less than or equal to 1% atomic percentage.

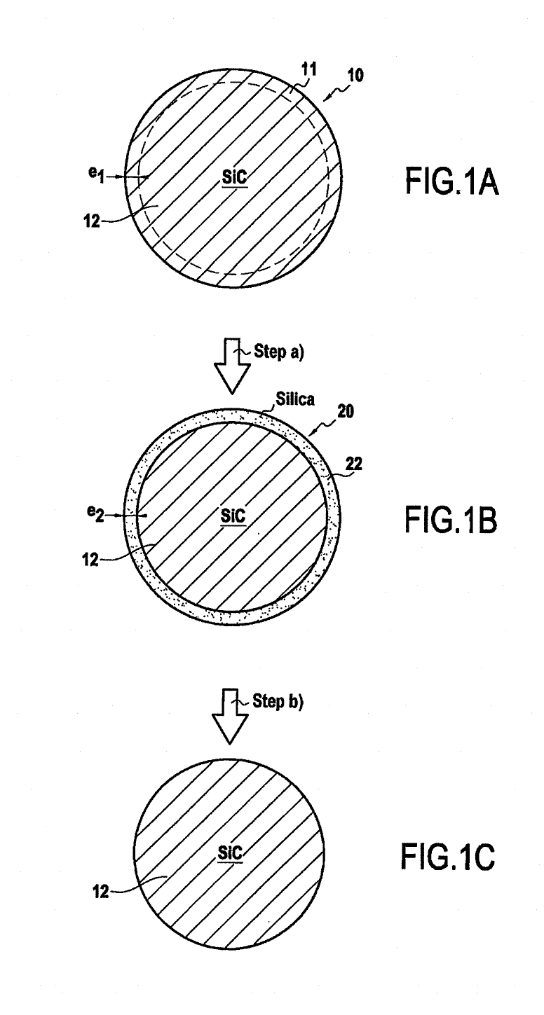

FIG. 1A shows in highly diagrammatic manner the section of a silicon carbide fiber 10 presenting an oxygen content that is less than or equal to 1% atomic percentage prior to performing the method of the invention. The silicon carbide fiber 10 is constituted by a core 12 made of silicon carbide and a surface layer 11 situated in the vicinity of the surface of the fiber 10. The surface layer 11 presents a surface state and composition that are non-uniform, comprising in particular carbon and at least one silicon oxycarbide. The surface layer 11 is responsible for a decrease in the quality of adhesion between the fiber and the interphase layer. The thickness e₁ of the surface layer 11 may typically be greater than or equal to 1 nm, e.g. 5 nm or 10 nm. The method of the invention serves to eliminate the surface layer 11.

The silicon carbide fibers may be treated in any form whatsoever, e.g. yarns, roving, twisted strands, tows, fabrics, felts, mats, and even two- or three-dimensional preforms. Silicon carbide fibers treated by the method of the invention may advantageously be used for making fiber preforms for composite material parts.

In order to form the fiber preform, a fiber texture may initially be obtained by performing one or more textile operations, with the fiber texture then being shaped in order to obtain a preform having the desired shape. The fiber texture may be obtained by three-dimensional weaving, e.g. using an interlock weave, i.e. a weave in which each layer of weft yarns interlinks a plurality of layers of warp yarns, with all of the yarns in a given weft column having the same movement in the weave plane. Other types of three-dimensional weaving could naturally be used in order to fabricate the fiber texture. When the fiber texture is made by weaving, the weaving may be performed using warp yarns extending in the longitudinal direction of the texture, it being understood that weaving with weft yarns in this direction is also possible. Various ways of weaving that are suitable for making the fiber texture are described in particular in Document WO 2006/136755.

The fiber texture may also be formed by assembling together at least two fiber structures. Under such circumstances, the fiber structures may be bonded together, e.g. by stitching or needling. Each of the fiber structures may in particular be obtained from a layer or a stack of a plurality of layers of:
one-dimensional (1D) fabric;
two-dimensional (2D) fabric;
braid;
knit;
felt;
one-dimensional (1D) sheet of yarns or tows or multi-dimensional (nD) sheets obtained by superposing a plurality of 1D sheets in different directions and bonding the 1D sheets together, e.g. by stitching, by a chemical bonding agent, or by needling.

When using a stack of a plurality of layers, they may, for example, be bonded together by stitching, by implanting yarns or rigid elements, or by needling.

The silicon carbide fibers may be treated by the method of the invention either before or after making the preform.

The treatment method of the invention is described below.

The silicon carbide fiber 10 presenting an oxygen content that is less than or equal to 1% atomic percentage is initially put into contact with an oxidizing medium. As a result of this contact, the surface layer 11 is oxidized and transformed into a layer 22 of silica presenting a thickness e₂ that, in the example shown, is substantially equal to the thickness e₁ of the surface layer 11 (see FIG. 1B). In a variant, the thickness of the silica layer that is formed may be greater than the thickness of the surface layer 11.

During step a), the fiber 10 may be put into contact with an oxidizing gas phase including the element O. In particular, during the step a), the fiber 10 may be put into content with air or with steam. In an implementation, the fiber 10 may be treated by the oxidizing gas phase at a treatment temperature lying in the range 600° C. to 1000° C., e.g. in the range 800° C. to 1000° C., preferably in the range 900° C. to 1000° C. The treatment performed during step a) may be performed at atmospheric pressure or at a pressure lower than atmospheric pressure. By way of example, it is thus possible to perform step a) under atmospheric pressure by treating the fiber 10 with an oxidizing gas phase while imposing a treatment temperature lying in the range 600° C. to 1000° C.

The silicon carbide fiber may be put into contact with the oxidizing medium during step a) for a duration that is longer than or equal to 1 minute (min), e.g. 5 min, e.g. 10 min, e.g. 30 min, this duration lying in the range 5 min to 60 min, for example.

Once the silica layer 22 has been obtained, it is subsequently eliminated during step b) by being dissolved by being put into contact with an acid liquid medium comprising at least hydrofluoric acid. The acid liquid medium used during step b) may be in the form of an acid aqueous solution, for example. Advantageously, the acid liquid medium is in the form of an aqueous solution including at least hydrofluoric acid. The concentration of hydrofluoric acid in the acid liquid medium may advantageously be greater than or equal to 0.5 moles per liter (mol/L).

In an implementation, the acid liquid medium may be in the form of an aqueous solution including at least a mixture of hydrofluoric acid and of nitric acid. When the acid liquid medium comprises a mixture of hydrofluoric acid and of nitric acid, the concentration of hydrofluoric acid in the acid liquid medium may advantageously be greater than or equal to 0.5 mol/L, and the concentration of nitric acid in the acid liquid medium may advantageously be greater than or equal to 0.5 mol/L. Under such circumstances, the concentration of nitric acid in the acid liquid medium may for example lie in the range 0.5 mol/L to 5 mol/L.

The temperature imposed during step b) may lie in the range 10° C. to 100° C., e.g. in the range 10° C. to 40° C. The duration for which the fibers are in contact with the acid liquid medium during step b) may for example be greater than or equal to 1 min, e.g. equal to 5 min, e.g. lying in the range 5 min to 60 min.

FIG. 1C shows the result obtained after performing steps a) and b). Under such circumstances, a silicon carbide fiber is obtained presenting a surface state and a composition that are uniform. In the example shown, after step b), the entire surface layer 11 is eliminated without substantially affecting the core 12 of the fiber. After performing steps a) and b), a fiber 12 is obtained that presents a surface of pure silicon carbide. This result is quite different from the result that would be obtained when a silicon carbide fiber presenting an oxygen content greater than 1% atomic percentage (e.g. a “Nicalon” fiber) is processed by an acid liquid medium, e.g. comprising a mixture of hydrofluoric acid and of nitric acid. Specifically, under such circumstances, instead of obtaining a uniform silicon carbide surface, a layer of carbon would be obtained at the surface of the treated fiber. In other words, the ability to strip the surfaces of silicon carbide fibers by the treatment of the invention is associated with using silicon carbide fibers presenting an oxygen content that is less than or equal to 1% atomic percentage.

An interphase layer is then deposited in contact with the surface of the fiber obtained after performing steps a) and b). Depositing the interphase layer directly on the surface of the fiber is performed in known manner. The fiber treated by the method of the invention presents improved bonding with the interphase layer. The interphase layer may be a layer of boron nitride (BN) or a layer of pyrolytic carbon (PyC). By way of example, the thickness of the interphase layer may be greater than or equal to 200 nm, e.g. lying in the range 200 nm to 300 nm. One or more additional layers may be deposited on the interphase layer, e.g. additional layers of ceramic material such as SiBC, BNSi, or silicon carbide.

Naturally, a plurality of silicon carbide fibers each presenting an oxygen content that is less than or equal to 1% atomic percentages may be treated simultaneously by the method of the invention.

Once the interphase layer has been deposited, it is then possible to form a part out of composite material having improved mechanical properties by densifying a fiber preform of treated fibers coated in the interphase layer with at least one matrix phase. The fiber preform constitutes the fiber reinforcement of the composite material part and the matrix phase is formed in the pores of the fiber preform. By way of example, the matrix phase may be made of silicon carbide or of carbon.

The densification is performed in known manner. The fiber preform can thus be densified using a liquid technique (impregnating it with a matrix precursor resin and transforming the resin by cross-linking and pyrolysis, which process may be repeated) or by a gas technique (chemical vapor infiltration (CVI) of the matrix). The invention applies in particular to making ceramic matrix composite (CMC) material parts constituted by fiber reinforcement made of silicon carbide fibers and densified with a ceramic matrix, in particular a carbide, nitride, refractory oxide, etc. matrix. Typically examples of such CMC materials are SiC—SiC materials (silicon carbide reinforcing fibers with a silicon carbide matrix). It is also possible to make the matrix phase by infiltrating silicon in the molten state, known as the “melt-infiltration” method.

### EXAMPLES

### Example 1

“Hi-Nicalon S” type fibers were put into contact with an oxidizing gas phase constituted by air while imposing a treatment temperature of 650° C. for a treatment duration of 45 min. Such treatment made it possible to transform the surface of the fibers chemically so as to form a surface silica layer. Analysis by secondary ion mass spectrometry (SIMS) made it possible to estimate the thickness of the silica layer formed in that way. The thickness of the silica layer was thus estimated as 1.6 nm.

The oxidized fibers presenting a silica surface layer were then arranged in five groups, and each group of fibers was subjected to treatment using a different acid solution. All of the acid treatments were performed by dipping the fibers in a bath of the acid solution for 1 hour (h) at a temperature of 30° C. The compositions of the five acid solutions used are listed below:
hydrofluoric acid solution at 80 grams per liter (g/L);
hydrofluoric acid solution at 448 g/L;
a solution comprising a mixture of hydrofluoric acid at 80 g/L and nitric acid at 180 g/L;
a solution comprising a mixture of hydrofluoric acid at 80 g/L and nitric acid at 325 g/L; and
a solution comprising a mixture of hydrofluoric acid at 470 g/L and nitric acid at 325 g/L.

Once those acid treatments had been performed, secondary ion mass spectrometry analysis confirmed that the silica surface layer had been eliminated for all five groups of fibers.

An interphase layer of boron nitride was then formed on the fibers obtained by performing the above-described oxidation followed by acid treatment with the solution of hydrofluoric acid at 448 g/L. The boron nitride interphase layer was formed directly on the surface of the silicon carbide fibers by performing the following operating conditions:
treatment with a gas phase comprising N₂, NH₃, and BCl₃;
imposing a temperature of 1100° C.;
imposing a pressure of 2 millibars (mbar);
setting a ratio alpha to 1 (i.e. the ratio of (NH₃ volume flow rate)/(BCl₃ volume flow rate));
setting a ratio beta to 10 (corresponding to the ratio (N₂ volume flow rate)/(volume flow rate of BCl₃+volume flow rate of NH₃)); and
setting a total volume flow rate for the treatment gas phase at 367 cubic centimeters per minute (cm³/min).

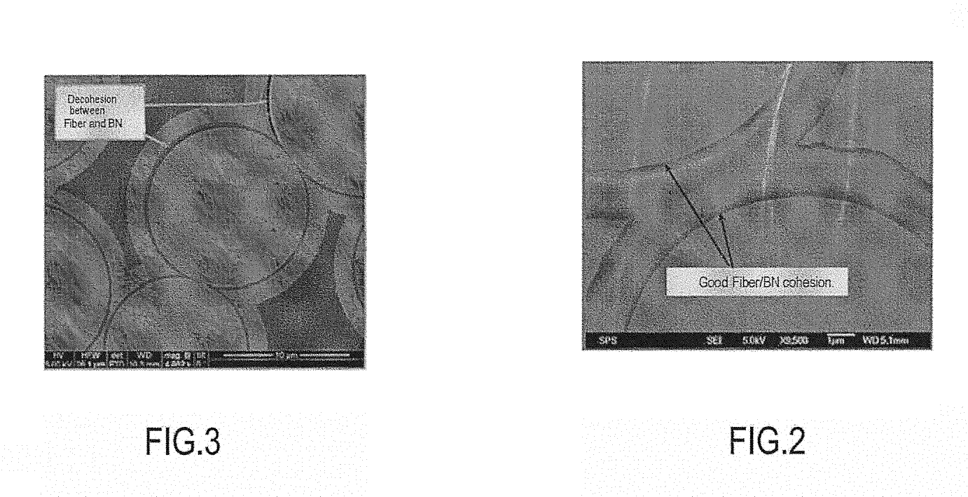

FIG. 2 is a photograph of the result obtained. Good cohesion can be observed between the fibers and the boron nitride interphase layer. The coated fibers as obtained in this way constitute fiber reinforcement for a composite material part and they confer improved mechanical properties to said part. FIG. 3 is provided by way of comparison and it shows that when the treatment of steps a) and b) of the invention is not performed, decohesion is observed between the fibers and the boron nitride interphase layer. This decohesion leads to a reduction in the mechanical properties of the composite material part formed from fibers coated in this way.

### Example 2

Another test was performed under the same conditions as in Example 1 except that the oxidation in step a) was performed by putting the fibers into contact with air at a temperature of 1000° C. for a treatment duration of 15 min. The thickness of the silica layer formed under such circumstances is estimated by secondary ion mass spectrometry as being about ten nanometers. After treatment by the acid medium, the same surface state was obtained for the fibers as in Example 1, and consequently similar mechanical properties were obtained.

### (Comparative) Example 3

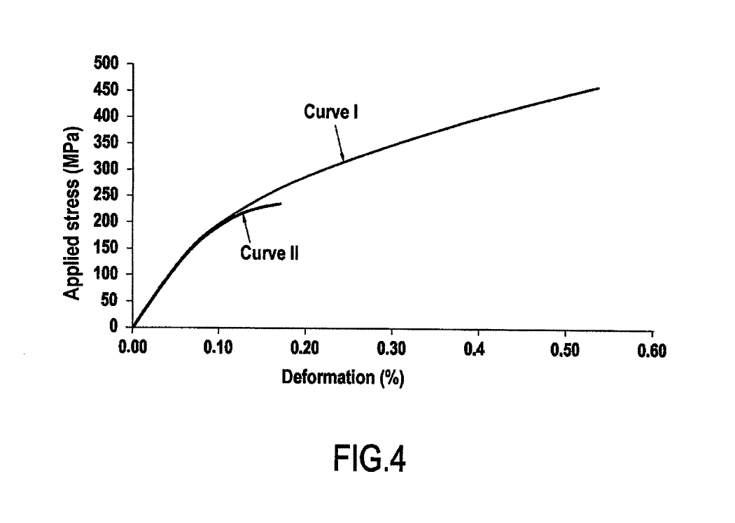

FIG. 4 shows the results obtained during a traction test between firstly a part obtained after treating fibers by a method in accordance with Example 1 (curve I) and secondly a part obtained after treatment of fibers in the same manner as in Example 1 with the exception that the prior oxidation treatment (step a)) was not performed (curve II). It can be seen that performing the treatment of the invention serves advantageously to improve very significantly the elongation at break of the resulting part.

The term “lying in the range . . . to . . . ” should be understood as including the bounds.

1. A method of treating at least one silicon carbide fiber, the method comprising at least the following steps:
a) putting at least one silicon carbide fiber presenting an oxygen content that is less than or equal to 1% in atomic percentage into contact with an oxidizing gas phase for a duration greater than or equal to 1 min and imposing a treatment temperature greater than or equal to 600° C. in order to transform the surface of the fiber chemically and form a surface layer of silica;
b) eliminating the resulting silica layer by putting the fiber obtained after performing step a) into contact with an acid liquid medium comprising at least hydrofluoric acid; and
c) depositing an interphase layer on the surface of the fiber obtained after performing step b).

2. A method according to claim 1, wherein the treatment temperature imposed during step a) lies in the range 600° C. to 1000° C.

3. A method according to claim 2, wherein the treatment temperature imposed during step a) lies in the range 900° C. to 1000° C.

4. A method according to claim 1, wherein the fiber is treated during step a) with air and/or with steam.

5. A method according to claim 1, wherein the acid liquid medium comprises a mixture of hydrofluoric acid and of nitric acid.

6. A method according to claim 1, wherein the interphase layer is a layer of boron nitride or of pyrolytic carbon.

7. A method according to claim 1, wherein the treatment is applied to a plurality of silicon carbide fibers each presenting an oxygen content that is less than or equal to 1% atomic percentage.

8. A method of fabricating a fiber preform comprising at least a step of treating a plurality of silicon carbide fibers by performing a method according to claim 7 and a step of forming a fiber preform by performing one or more textile operations using said plurality of fibers treated in this way.

9. A method of fabricating a fiber preform comprising at least a step of forming a fiber preform by performing one or more textile operations using a plurality of silicon carbide fibers, each presenting an oxygen content that is less than or equal to 1% atomic percentage, and a step of treating said plurality of fibers, once the preform has been formed, by performing a method according to claim 7.

10. A method of fabricating a composite material part comprising at least a step of fabricating a fiber preform by performing a method according to claim 8, followed by a step of forming at least one matrix phase of carbon or of ceramic material in order to densify said fiber preform.

11. A method according to claim 10, wherein the composite material part is a turbine engine blade.
